(19) United States
(12) Patent Application Publication
(10) Pub. No.: US 2011/0316822 A1
(43) Pub. Date: Dec. 29, 2011

(54) IMAGE DISPLAY DEVICE

(75) Inventor: Minoru TAGI, Tokyo (JP)

(73) Assignee: Casio Computer Co., Ltd., Tokyo (JP)

(21) Appl. No.: 13/169,217

(22) Filed: Jun. 27, 2011

(30) Foreign Application Priority Data
Jun. 28, 2010 (JP) 2010-145782

(51) Int. Cl. G09G 5/00; G06K 9/40

(52) U.S. Cl. 345/204; 382/254

(57) ABSTRACT

An image display device, which displays image data on a display section, includes a vibration section which vibrates a housing constituting the device, analyzes video data displayed on the display section to detect a changing state of an image of the video data, and controls the driving of the vibration section based on the detected changing state of the image.

### CROSS-REFERENCE TO RELATED APPLICATION

This application is based upon and claims the benefit of priority from the prior Japanese Patent Application No. 2010-145782, filed Jun. 28, 2010, the entire contents of which is incorporated herein by reference.

### BACKGROUND OF THE INVENTION

1. Field of the Invention

The present invention relates to an image display device including a vibrating section that vibrates a housing.

2. Description of the Related Art

In recent years, playback-only devices referred to as digital photo frames have been commercialized as devices that display images captured by digital cameras. These digital photo frames have an advantage in that their users can set them in desired locations and freely view the images at any time. However, simply and constantly displaying the same photographs soon bore the users, and as a result the users begin to ignore the photographs.

As a solution to this problem, a technology such as that described in Japanese Patent Application Laid-Open (Kokai) Publication No. 2009-141678 is known in which an overall photograph (image) is displayed in sepia tone depending on when the photograph has been captured, thereby expressing the oldness of the photograph and catching the user's interest.

However, in the above-described conventional technology, although a sepia-toned image switches to its original image depending on the user's image viewing time, the user's attention is not strongly attracted.

Also, contents that can be replayed in digital photo frames are not limited to still images. Video and audio can also be replayed. Accordingly, with the increased variety of contents, more attractive expressions (effects) are being required.

### SUMMARY OF THE INVENTION

An object of the present invention is to strongly attract the attention of a user by a special expression during the playback of images.

In order to achieve the above-described object, in accordance with one aspect of the present invention, there is provided an image display device that displays image data on a display section, comprising: a vibration section which vibrates a housing constituting the image display device; a detection section which analyzes video data that is displayed on the display section and thereby detects a changing state of an image in the video data; and a vibration control section which controls driving of the vibration section based on the changing state of the image detected by the detection section.

In accordance with another aspect of the present invention, there is provided an image display device that displays image data on a display section, comprising: a vibration section which vibrates a housing constituting the image display device; a detection section which analyzes additional data that has been added to the image data that is displayed on the display section and thereby detects a changing state of the additional data; and a vibration control section which controls driving of the vibration section based on the changing state of the additional data detected by the detection section.

In accordance with another aspect of the present invention, there is provided an image display device of a photo frame type including a display section, a storage section, a vibration section which vibrates a housing, and a processor; wherein the storage section stores video data; and the processor analyzes the video data and thereby detects a changing state of an image in the video data, generates vibration control data based on the detected changing state of the image, and controls driving of the vibration section based on the generated vibration control data when displaying the video data stored in the storage section on the display section.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing basic components of a digital photo frame to which an image display device according to the present invention has been applied;

FIG. 2A is a front view of the outer appearance of the digital photo frame;

FIG. 2B is a side view of the digital photo frame;

FIG. 3A and FIG. 3B are diagrams for explaining an image data storage section M2 and a management information storage section M3;

FIG. 4 is a flowchart of image registration processing for registering image data;

FIG. 5, FIG. 6, and FIG. 7 are flowcharts describing in detail management information registration processing (Step A4 in FIG. 4);

FIG. 8 and FIG. 9 are flowcharts of image playback processing (slide show display processing); and

FIG. 10A to FIG. 10D are diagrams showing examples of a display operation of the digital photo frame.

### DETAILED DESCRIPTION OF THE PREFERRED EMBODIMENTS

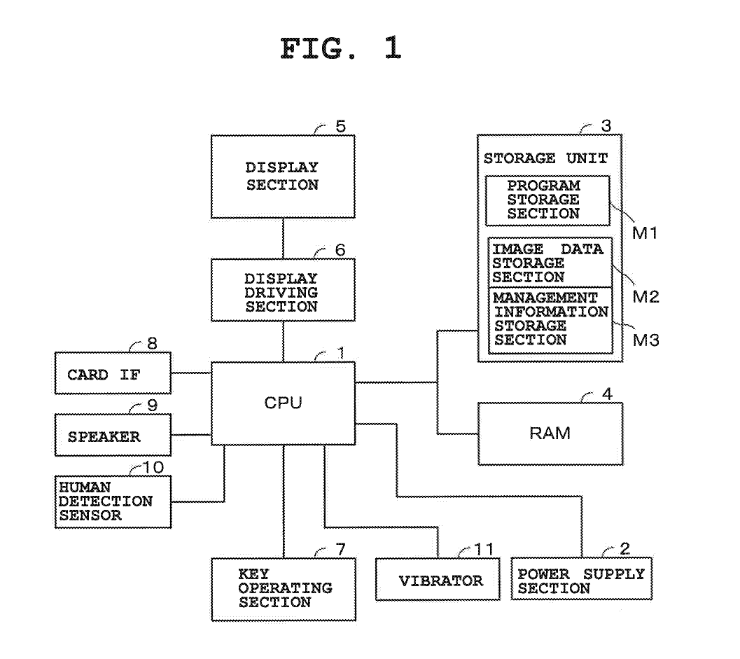

FIG. 1 is a block diagram showing basic components of a digital photo frame to which an image display device according to the present invention has been applied.

This digital photo frame has a slide show function that sequentially reads out a series of image data and displays them in succession, a clock function that acquires time information, etc., and is configured to operate with a central processing unit (CPU) 1 (detection section and vibration control section) serving as a core. The CPU 1 operates by receiving power supply from a power supply section (such as a commercial power source or a secondary battery) 2, and controls the overall operations of the digital photo frame based on various programs stored in a storage unit 3 (storage section). The storage unit 3 is, for example, a read-only memory (ROM), a hard disk, a flash memory, or a combination thereof, and has a program storage section M1, an image data storage section M2, a management information storage section M3, etc.

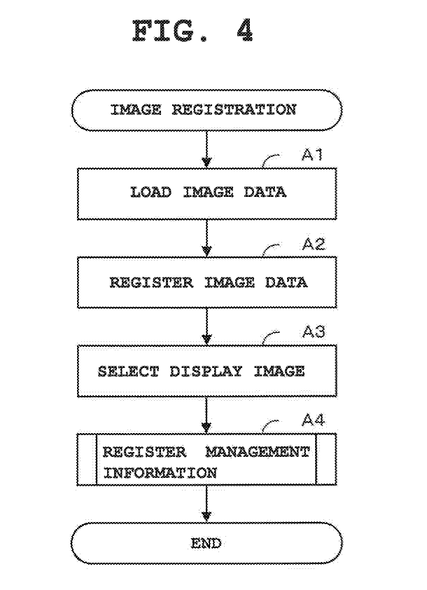

The program storage section M1 stores a program for actualizing the present embodiment based on the operation procedures shown in FIG. 4 to FIG. 9, and various applications, as well as various information required therefor. The image data storage section M2 is an area that stores various image data (still image data, video data, and partial video data) to be replayed. The management information storage section M3 is an area that stores management information (described hereafter) associated one-to-one with image data stored in the image data storage section M2. This management information is related to the display of associated image data. A random access memory (RAM) 4 is a work area that temporarily stores various information such as flag information and screen information required for the operation of the digital photo frame.

A display section 5, which is constituted by, for example, a high-definition liquid crystal display, an electroluminescence (EL) display, or an electrophoretic display (electronic paper), is driven under the control of a display driving section 6 (display switching section), and displays images, time and date, and the like in high definition. The CPU 1 reads out image data stored in the image data storage section M2 and supplies the image data to the display driving section 6. The display driving section 6 operates in response to a display control signal from the CPU 1, and performs display control to display image data from the CPU 1 on the display section 5 and to switch the image data in response to a display switching signal from the CPU 1.

Note that the display section 5 may constitute a touch screen by a contact operating section that detects finger contact being layered over the surface thereof. A touch panel using a capacitance method, a resistive film method, or a piezoelectric method may be used as this contact operating section.

A key operating section 7 includes various keys in a push-button format (not shown). For example, a key for turning the power ON and OFF, a key for selecting an image to be displayed, and a key for adjusting vibration intensity described hereafter are included therein. The CPU 1 performs power ON/OFF processing, image selection processing, vibration intensity adjustment processing, or the like as processing based on an input operation signal sent from the key operating section 7.

A card interface (IF) 8 exchanges image data with a memory card (not shown) connected by being inserted into a card slot (not shown in FIG. 1). The CPU 1 reads out and acquires image data from the memory card (such as a secure digital [SD] card), and registers the acquired image data by storing it in the image data storage section M2. Note that a universal serial bus (USB) interface may be provided, and image data may be inputted from a USB memory.

A speaker 9 is a sound speaker that, when a playback subject is image data with audio, generates and outputs the audio based on audio data that has been added to the image data.

A human detection sensor 10 (human detection section) detects whether or not a user is positioned near the display section 5 (whether or not the user is viewing the display section 5). For example, the human detection sensor 10 uses a sensor that receives infrared rays generated by a human body, converts the infrared rays to heat, and changes the heat to electric charge using the pyroelectric effect. The CPU 1 controls the driving of a vibrator 11 (vibration section) on a condition that a user is positioned near the display section 5.

The vibrator 11 is constituted by a vibration motor and a drive circuit therefor, and vibrates the overall housing of the digital photo frame. In this instance, the drive circuit adjusts the intensity of vibration by changing the amount of energization to the vibration motor under the control of the CPU 1. The vibration waveform of the vibrator 11 is, for example, a waveform such as a sine wave which is regularly repeated. However, it may be arbitrarily determined, and may be a waveform that changes over time.

The CPU 1 drives the vibrator 11 to surprise the user or attract the user's attention during image playback. That is, during image playback, the CPU 1 analyzes image data displayed on the display section 5 to detect the changing state of the image thereof, and drives the vibrator 11 based on the detected changing state (amount of change). In addition, the CPU 1 analyzes audio data that has been added to the image as additional data so as to detect the changing state of the audio thereof, and drives the vibrator 11 based on the detected changing state (amount of change).

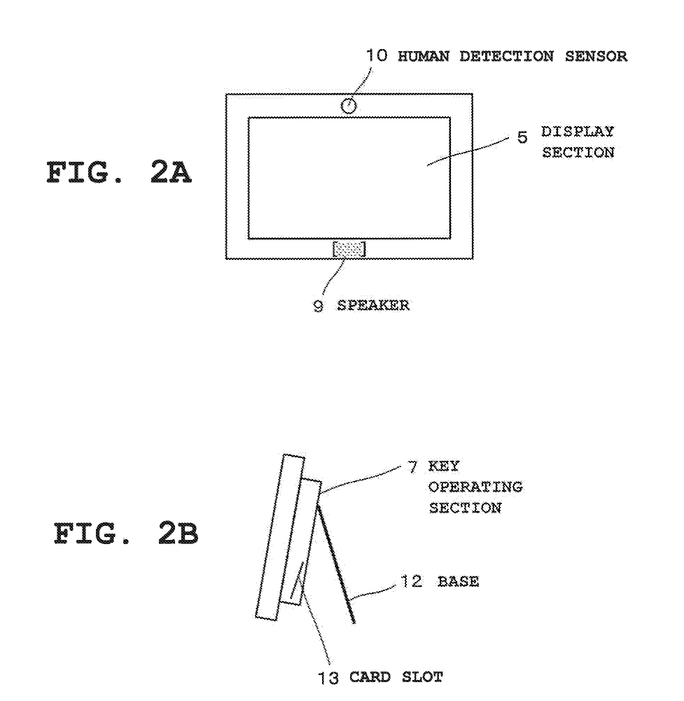

FIG. 2 is an outer appearance view of the digital photo frame.

The overall digital photo frame forms a substantially rectangular thin housing, and is a standing type where the rectangular housing is placed upright to be horizontally long.

FIG. 2A is a front view of the digital photo frame in a standing state. The display section 5 is arranged in the substantially overall area of the front surface of the housing, and the speaker 9 is arranged in a center portion below the display section 5. The human detection sensor 10 is arranged in a center portion above the display section 5.

FIG. 2B is a side view of the digital photo frame in a standing state. A base 12 that supports and holds the housing, and the key operating section 7 are arranged on the back surface of the housing. In addition, a card slot 13 into which an SD card or the like is inserted to be connected is arranged on one side surface of the housing. Although not shown in FIG. 1, the vibrator 11 is arranged, for example, in the lower portion side of the housing. Note that a portion in which the vibrator 11 is arranged may be arbitrarily determined.

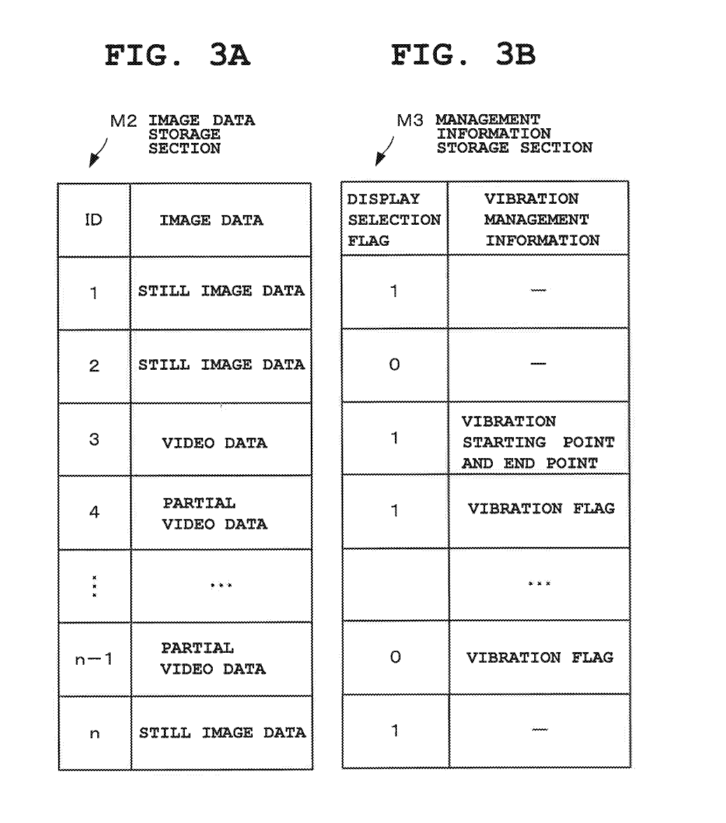

FIG. 3A and FIG. 3B are diagrams for explaining the image data storage section M2 and the management information storage section M3.

The image data storage section M2 sequentially stores image data acquired from a memory card (such as an SD card) via the card IF 8. As shown in FIG. 3A, “ID” and “image data” are stored in the image data storage section M2. “ID” is a serial number for identifying image data. The types of image data are still image data, video data, and partial video data.

“Image data” stored in the image data storage section M2 includes actual data, and additional data constituted by classification data indicating whether or not image data is a still image, a video with audio, a video without audio, or a partial video, and the image name (title) of the image data.

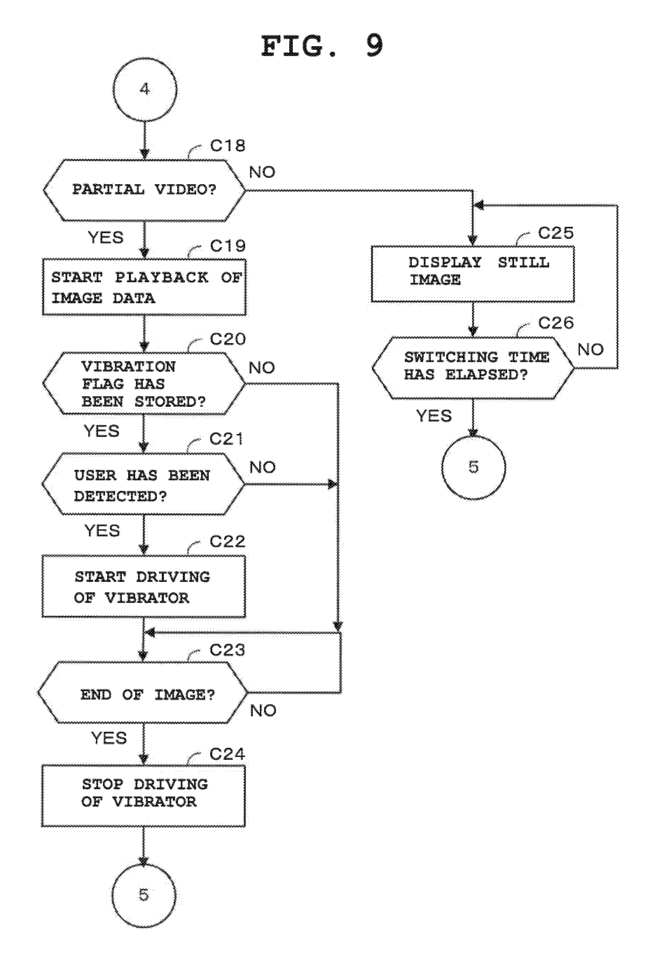

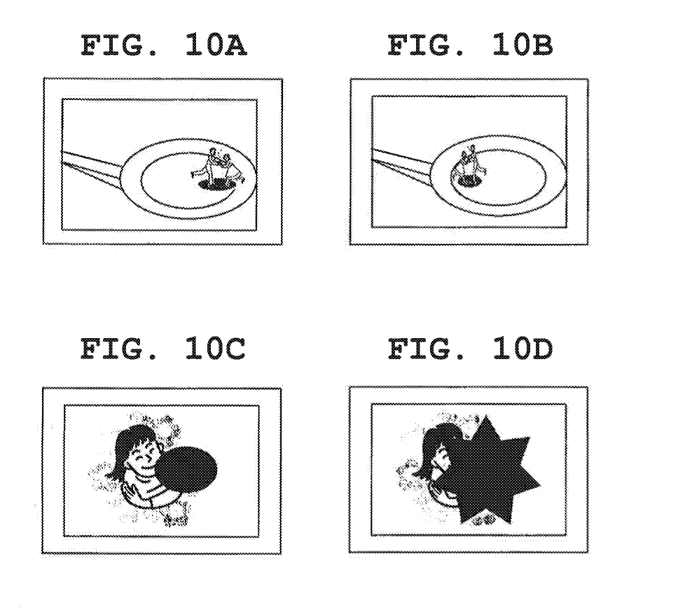

The partial video data herein refers to a composite image of a short partial video of about five seconds and a still image that serves as the background. For example, the partial video data in FIG. 10A and FIG. 10B is a composite image of a still image of a frying pan and a video of two people dancing. With regard to the video with audio, its audio data is also included in “image data” as additional data.

The management information storage section M3 stores management information related to and associated one-to-one with image data stored in the image data storage section M2. As shown in FIG. 3B, this management information is constituted by “display selection flag” and “vibration management information”. “Display selection flag” indicates that corresponding image data has been selected by user operation as a display subject. In FIG. 3B, “1” indicates that corresponding image data is a display subject and “0” indicates that corresponding image data is not a display subject. In a slide show display, images of image data whose “display selection flag” has been set to “1” are read out and sequentially displayed in “ID” numerical order.

“Vibration management information” is management information related to vibration control, and indicates how the vibrator 11 is driven. During image registration, the CPU 1 analyzes image data or additional data (audio data) that has been added to the image so as to detect the changing state of the image or the changing state of the audio, and generates information for controlling the vibration of the vibrator 11. “Vibration management information” includes “vibration starting point and ending point” data and “vibration flag”. “Vibration starting point and ending point” indicates a vibration start timing for driving the vibrator 11 when image data is a movie and a vibration end timing for stopping the driving of the vibrator 11.

That is, “vibration starting point and ending point” is a vibration timing (starting point: start time) indicating the amount of elapsed time from a reference position, which is a display starting position (time) of image data, until the driving of the vibrator 11 is started, and an end timing (ending point: end time) indicating the amount of elapsed time from the starting point until the consecutive driving of the vibrator 11 is ended. Note that a plurality of “vibration starting points and ending points” can be stored for a single image data. However, the number of times the vibration is performed may be limited to, for example, three times.

“Vibration flag” is a flag that, when image data is a partial video (composite image), indicates whether or not the vibrator 11 is driven during the playback of the partial video. Note that, when the image data is a still image, the vibrator 11 is not driven during image playback.

Next, operations of the digital photo frame of the embodiment will be described with reference to the flowcharts in FIG. 4 to FIG. 9. Here, each function described in the flowcharts is stored in a program code format readable by a computer, and operations based on these program codes are sequentially performed. Operations based on the above-described program codes transmitted over a transmission medium can also be sequentially performed. That is, the unique operations of the embodiment can be performed using a program and data supplied from an outside source over a transmission medium, in addition to a recording medium.

FIG. 4 is a flowchart of image registration processing for registering image data.

The image registration processing is performed to store and register image data supplied from an external source in the storage unit 3 in the image display device. During the registration of the image data, processing for generating and registering the above-described vibration management information is also performed.

First, the CPU 1 loads a plurality of image data from the memory card (such as SD card) via the card IF 8 (Step A1), and sequentially stores (registers) the image data in the image data storage section M2 (Step A2). Then, after finishing the registration of the image data, the CPU 1 performs display image selection processing (Step A3). In the display image selection processing, the CPU 1 reads out an image name (title) from each image data registered in the image data storage section M2, and displays a list of these image names on the display section 5. Next, the CPU 1 prompts the user to arbitrarily select an image to be displayed from the list screen. When user operation is performed, the CPU 1 accesses the management information storage section M3 and sets “display selection flag” corresponding to an image selected by the user operation to “1”. Then, when the display image selection processing is completed, the CPU 1 proceeds to management information registration processing to register “vibration management information” (Step A4).

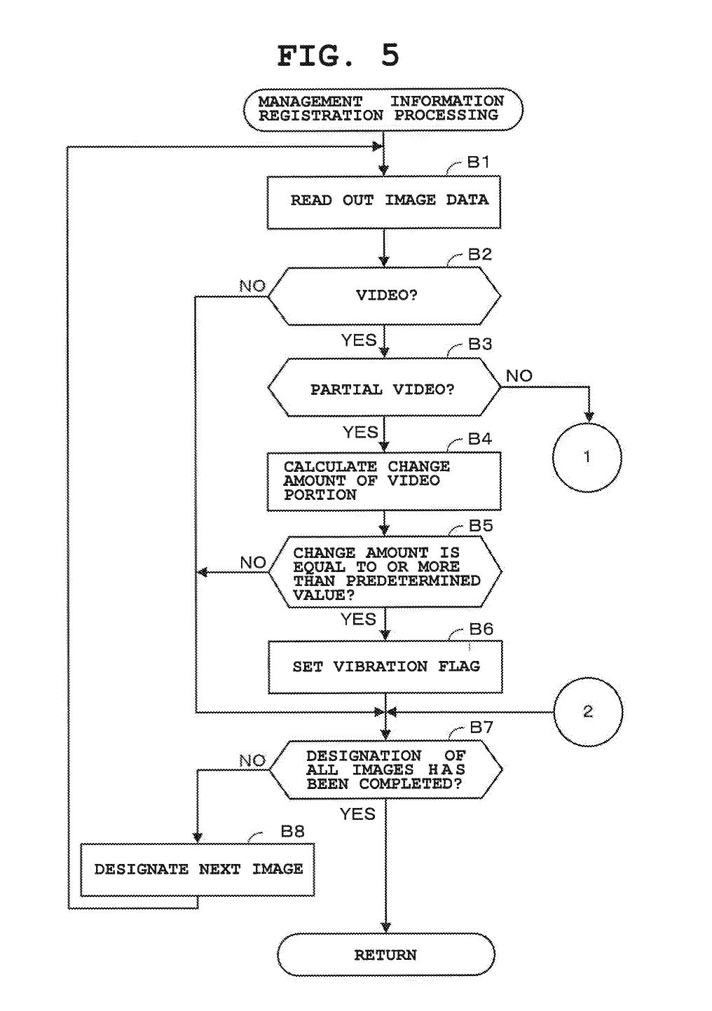

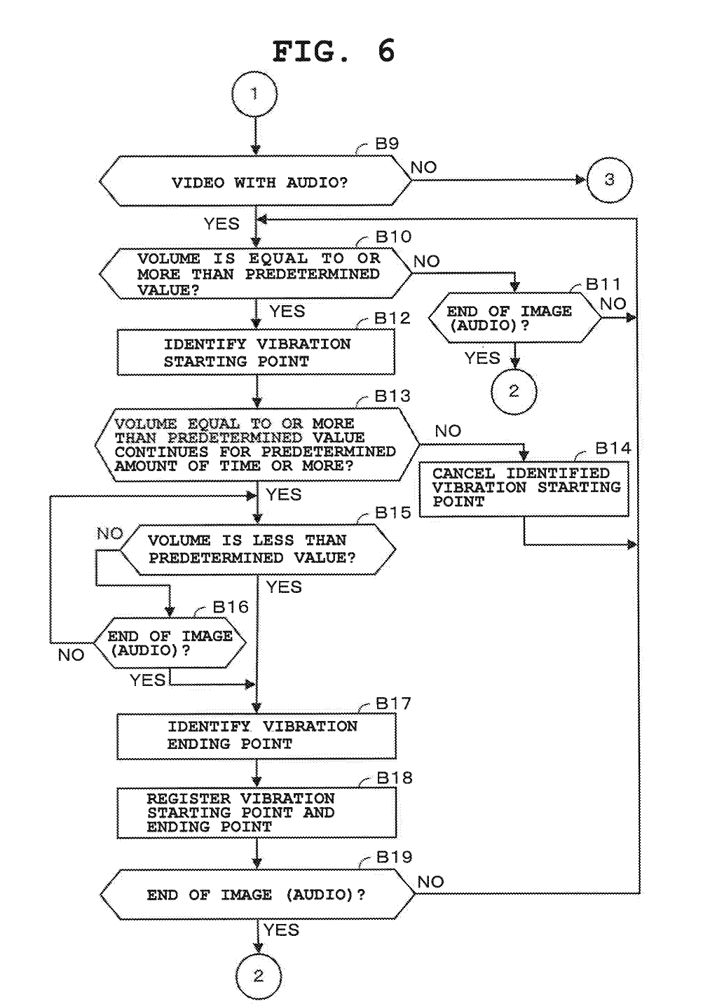

FIG. 5 to FIG. 8 are flowcharts explaining in detail the management information registration processing (Step A4 in FIG. 4).

The management information registration processing is, when image data is a video (a video with audio or a video without audio) or a partial video, performed to register “vibration starting point and ending point” data or “vibration flag” as “vibration management information” in the management information storage section M3 in association with the video.

First, the CPU 1 reads out the first image data (ID=1) in the image data storage section M2 (Step B1 in FIG. 5), and judges whether or not the classification of the image data is video (Step B2). When judged that the image data is a still image (NO at Step B2), the CPU 1 proceeds to Step B7 without registering vibration management information for the image data. When the image data is a video (YES at Step B2), the CPU 1 judges whether or not the type of the video is a partial video (Step B3).

When judged that the image data read out from the image data storage section M2 is a partial video (YES at Step B3), the CPU 1 focuses on and analyzes the video portion of the image data, and calculates the change amount thereof (Step B4). The change amount can be acquired by the center of the image of the video portion being determined and the amount of the movement of the center position being calculated, or the enlargement and reduction rates of the size (area) of the image of the video portion being calculated. For example, in the case of the video shown in FIG. 10A and FIG. 10B in which people are dancing on a frying pan (still image), the movement start position shown in FIG. 10A is determined as a reference, the position shown in FIG. 10B is determined as the position farthest from the reference position, and the distance (maximum value) from the reference position to the position shown in FIG. 10B is calculated as the change amount (movement amount) of the video portion.

Then, the CPU 1 judges whether or not the calculated change amount is equal to or more than a predetermined value, such as one-third or more of the length of the display section 5 in the horizontal direction (Step B5). When judged that the change amount is less than the predetermined value (NO at Step B5), the CPU 1 proceeds to Step B7 without registering vibration management information for the image data. When judged that the change amount is equal to or more than the predetermined value (YES at Step B5), the CPU 1 sets “1” as “vibration flag” in the management information storage section M3 in association with the image data, and registers vibration management information for the image data (Step B6). Then, at Step B7, the CPU 1 judges whether or not the designation of all image data up to the last image data (ID=n) in the image data storage section M2 has been completed. When judged that the designation of all the image data has not been completed, the CPU 1 designates remaining image data until all the image data is designated (Step B8), and then returns to the first Step B1. As just described, in the case of a partial video, “vibration flag” is registered as vibration management information therefor on the condition that the change amount (movement amount) of the partial video is equal to or more than a predetermined value.

At Step B3, when judged that the type of the video is not a partial video (NO at Step B3), the CPU 1 judges whether or not the image data is a video with audio (Step B9 in FIG. 6). When judged that the image data is a video with audio (YES at Step B9), the CPU 1 analyzes audio data that has been added to the image data and searches for a position (time) at which the volume suddenly becomes loud. That is, the CPU 1 judges whether or not the change amount of the audio data (the volume) is equal to or more than a predetermined value (Step B10). When judged that the volume is less than the predetermined value (NO at Step B10), the CPU 1 judges whether or not the analysis has been performed to the end of the image data (audio data) (Step B11). When judged that the analysis has not been performed to the end (NO at Step B11), the CPU 1 returns to above-described Step B10, and judges whether or not the volume is equal to or more than the predetermined value. When judged that the volume is less than the predetermined value (NO at Step B10) and that the end of the video data (audio data) has been detected (YES at Step B11), the CPU 11 proceeds to Step B7 in FIG. 5 without registering vibration management information for the video with audio.

When a position at which the volume is equal to or higher than the predetermined value is detected (YES at Step B10), the CPU 1 identifies the position as a vibration starting point (time point) (Step B12). Then, the CPU 1 judges whether or not the volume that is equal to or higher than the predetermined value continues for a predetermined amount of time (such as less than a second) or more (Step B13). For example, in the case of the video with audio shown in FIG. 10C and FIG. 10D where a balloon starts to expand in FIG. 10C and bursts in FIG. 10D, the CPU 1 judges whether or not the bursting sound (including the resonance thereof) continues for a second or more.

When judged that the duration time of the volume that is equal to or higher than the predetermined value is less than the predetermined amount of time (NO at Step B13), the CPU 1 cancels the vibration starting point identified at above-described Step B12 (Step B14) and returns to above-described Step B10 to identify a new starting point. When judged that the volume that is equal to or higher than the predetermined value continues for the predetermined amount of time or more (YES at Step B13), the CPU 1 searches for a position (time) at which the volume decreases and becomes less than a predetermined value (Step B15). When a position (time) at which the volume becomes lower than the predetermined value is found (YES at Step B15), the CPU 1 identifies the position as a vibration ending point (time point) (Step B17). Then, the CPU 1 associates the identified vibration starting point with the vibration ending point, and registers them in the management information storage section M3 as vibration management information (Step B18). Next, the CPU 1 judges whether or not the analysis has been performed to the end of the image data (audio data) (Step S19). When judged that the analysis has not been performed to the end (NO at Step B19), the CPU 1 returns to above-described Step B10 and performs processing for identifying the next position at which the volume becomes large.

Conversely, when judged that the analysis has been performed to the end of the image data (audio data) (YES at Step B16) without a position at which the volume becomes less than the predetermined value being detected (NO at Step B15), the CPU 1 identifies the position at this point as a vibration ending point (time point) (Step B17).

As a result of the above-described processing, a plurality of vibration starting points and vibration ending points can be registered depending on the changing state of the volume. When judged that the analysis has been completed to the end of the image data (audio data) (YES at Step B19), the CPU 1 proceeds to Step B7 in FIG. 5, and judges whether or not the designation of all the image data has been completed. When judged that unprocessed image data remains, the CPU 1 designates the remaining image data (Step B8), and then returns to the first Step B1. As just described, in the case of a video with audio, “vibration starting point and ending point” is registered as vibration management information therefor on the condition that the audio of the video with audio is equal to or more than a predetermined value.

When judged that the type of the video is a video without audio (NO at Step B9 in FIG. 6), the CPU 1 focuses on a moving portion (such as a portion including a moving person or animal), and analyzes the moving portion to calculate the change amount of the moving portion (Step B20 in FIG. 7). In this instance, the CPU 1 calculates the amount of change per predetermined amount of time (such as one second). Note that any one of the amount of change in size, the amount of change in position, the amount of change in color, and the amount of change in brightness may be detected as the change amount of the image data. Alternatively, a total change amount of a combination of two or more of the amount of change in size, the amount of change in position, the amount of change in color, and the amount of change in brightness may be detected.

Then, the CPU 1 judges whether or not the change amount of the image data is equal to or more than a predetermined value (Step B21). For example, when detecting the amount of change in position, the CPU 1 judges whether or not the movement of the moving portion is large, in other words, one-third or more of the length of the display section 5 in the horizontal direction. When judged that the change amount is less than the predetermined value (NO at Step B21), the CPU 1 judges whether or not the analysis has been performed to the end of the image data (Step B22). When judged that the analysis has not been performed to the end of the image data (NO at Step B22), the CPU 1 returns to above-described Step B20. Then, when judged that the change amount of the image data is still less than the predetermined value (NO at Step B21) and that the end of the image data has been detected (YES at Step B22), the CPU 1 proceeds to Step B7 in FIG. 5 without registering vibration management information for the video. When judged that the change amount of the image data is equal to or more than the predetermined value (YES at Step B21), the CPU 1 identifies this position as a starting point (Step B23) Then, the CPU 1 judges whether or not the change amount that is equal to or more than the predetermined value continues for a predetermined amount of time (such as less than a second) or more (Step B24).

When judged that the duration time of the change amount that is equal to or more than the predetermined value is less than the predetermined amount of time (NO at Step B24), the CPU 1 cancels the vibration starting point identified at above-described Step B23 (Step B25) and returns to above-described Step B20 to identify a new starting point. When judged that the change amount that is equal to or more than the predetermined value continues for the predetermined amount of time or more (YES at Step B24), the CPU 1 judges whether or not the change amount has decreased to become less than the predetermined value (Step B26), When judged that the change amount is still equal to or more than the predetermined value (NO at Step B26), the CPU 1 judges whether or not the analysis has been performed to the end of the image data (Step B27). When judged that the change amount of the image data has decreased to become less than the predetermined value (YES at Step B26), or when the change amount remains at the predetermined value or more until the end of the image data (YES at Step B27), the CPU 1 identifies the position at this point as a vibration ending point (time point) (Step B28). Then, the CPU 1 associates the above-described vibration starting point with the identified vibration ending point, and registers them in the management information storage section M3 as vibration management information (Step B29).

Then, the CPU 1 judges whether or not the analysis has been performed to the end of the image data (Step B30). When judged that the analysis has not been performed to the end (NO at Step B30), the CPU 1 returns to Step B20. As a result, a plurality of vibration starting points and vibration ending points are registered. As just described, in the case of a video without audio, “vibration starting point and vibration ending point” is registered as vibration management information therefor on the condition that the changing state of the image is equal to or more than a predetermined value.

When judged that the analysis has been performed to the end of the image data (YES at Step B30), the CPU 1 proceeds to Step B7 in FIG. 5, and judges whether or not the designation of all image data up to the end of the image data storage section M2 has been completed. When judged that the designation of all the image data has not been completed, the CPU 1 designates remaining image data until the designation of all the image data is completed (Step B8), and then returns to the first Step B1. Hereafter, as a result of the operations such as those described above being repeated, when all the image data up to the end (ID=n) of the image data storage section M2 are designated by the above-described operations being repeated (YES at Step B7), the processing flows in FIG. 5 to FIG. 7 are completed.

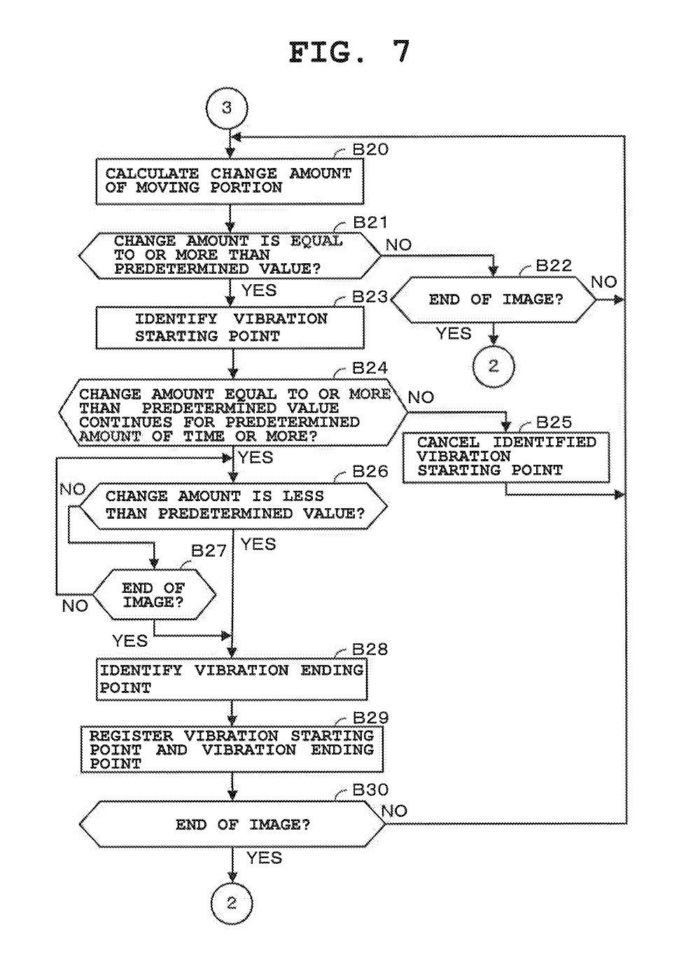

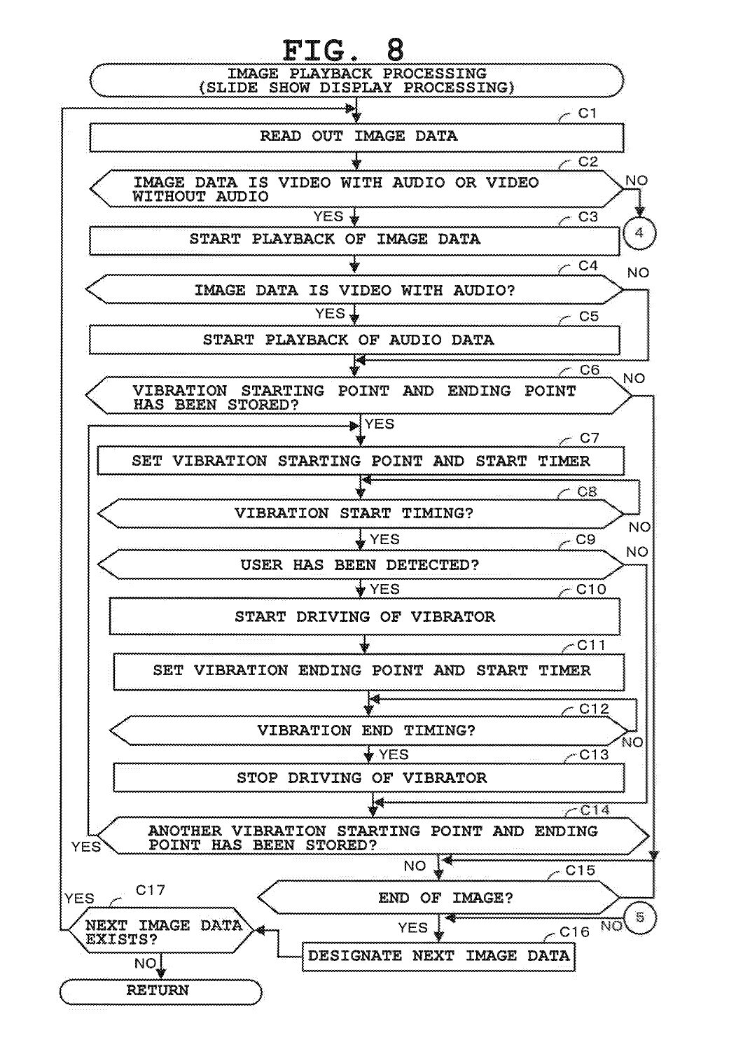

FIG. 8 and FIG. 9 are flowcharts of image playback processing (slide show display processing).

First, the CPU 1 reads out image data to be displayed whose “display selection flag” is “1” from the image data storage section M2 (Step C1 in FIG. 8). Next, the CPU 1 judges whether the image data is a video with audio or a video without audio (Step C2), or a partial video (Step C18 in FIG. 9).

When judged that the read image data is a still image (NO at Step C18 in FIG. 9), the CPU 1 displays the image data (still image data) on the display section 5 (Step C25), and repeats Step C25 to continue the still image display until a predetermined switching time (such as five seconds) elapses (NO at Step C26). Then, after displaying the still image for the predetermined amount of time (YES at Step C26), the CPU 1 designates the next image data (Step C16), and returns to the first Step C1 to read out the designated image data, on a condition that subsequent unprocessed image data exists (YES at Step C17). Hereafter, when sequentially reading out still images, the CPU 1 reads out these still images such that a displayed still image is switched to a read still image every time a still image is read out.

At Step C2, when judged that the image data read out from the image data storage section M2 is a video with audio or a video without audio (YES at Step C2), the CPU 1 starts an image playback operation and displays the video data on the display section 5 (Step C3). In the case of a video without audio (YES at Step C4), the CPU 1 generates and outputs the audio from the speaker 9 based on the audio data (Step C5). Next, the CPU 1 judges whether or not “vibration starting point and ending point” has been stored in the management information storage section M3 in association with the image data (Step C6). When judged that “vibration starting point and ending point” has not been stored (NO at Step C6). the CPU 1 proceeds to Step C15 and judges whether or not the playback has been performed to the end of the image data (Step C15). When judged that the playback has not been performed to the end of the image data (No at Step C15), the CPU 1 continues the playback operation to the end. When judged that the playback has been performed to the end of the image data (YES at Step C15), the CPU 1 designates the next image data as a playback subject (Step C16), and returns to the first Step C1 to read out the designated image data, on a condition that subsequent unprocessed image data exists (YES at Step C17).

At Step C6, when judged that “vibration starting point and end point” has been stored in association with the image data (YES at Step C6), the CPU 1 sets the vibration starting point in a control timer (not shown), and starts a clocking operation of the control timer (Step C7). Next, the CPU 1 judges whether or not the control timer has reached time-up or, in other words, whether or not the control timer has reached the vibration start timing (Step C8). Then, when judged that the control timer has not reached the vibration start timing (No at Step C8), the CPU 1 enters a wait state until the control timer reaches the vibration starting timing (No at Step C8). When judged that the control timer has reached the vibration start timing (YES at Step C8), the CPU 1 judges whether or not a user is positioned near the display section 5 (whether or not a user is viewing the display section 5) based on an output signal from the human detection sensor 10 (Step C9) When judged that no user is positioned near the display section 5 (NO at Step C9), the CPU proceeds to Step C14 to cancel the activation of the vibrator 11. When judged that a user is positioned near the display section 5 (YES at Step C9), the CPU 1 starts the driving of the vibrator 11 based on this condition (Step C10). In this instance, the CPU 1 drives the vibrator 11 at an intensity adjusted in advance by vibration adjustment processing.

Then, after setting the vibration ending point in the control timer (not shown) and starting the clocking operation of the control timer (Step C11), the CPU 1 judges whether or not the control timer has reached time-up or, in other words, whether or not the clock timer has reached the vibration end timing (Step C12), When judged that the control timer has not reached the vibration start timing (No at Step C12), the CPU 1 continues the driving of the vibrator 11 until the clock timer reaches the vibration end timing. When judged that the control timer has reached the vibration start timing (YES at Step C12), the CPU 1 stops the driving of the vibrator 11 (Step C13). Then, the CPU 11 judges whether or not another “vibration starting point and ending point” has been stored in association with the image data being replayed (Step C14).

When judged that another “vibration starting point and ending point” has been stored (YES at Step C14), the CPU 1 returns to above-described Step C7, and repeats the same vibration operation. When judged that another “vibration starting point and ending point” has not been stored (NO at Step C14), and that the playback has not been performed to the end of the image data (NO at Step C15), the CPU 1 continues the playback operation to the end of the image data. When judged that the playback has been performed to the end of the image data (YES at Step C15), the CPU 1 designates the next image data as a playback subject (Step C16), and returns to the first Step C1 to read out the designated image data, on a condition that subsequent unprocessed image data exists (YES at Step C17).

At Step C18, when judged that the image data read out from the image data storage section M2 is a partial video (YES at Step C18 in FIG. 9), the CPU 1 starts a playback operation to display the image data (partial video) on the display section 5 (Step C19). Next, the CPU 1 judges whether or not “vibration flag” has been stored in the management information storage section M3 in association with the image data (partial video) (Step C20). When judged that “vibration flag” has not been stored (NO at Step C20), the CPU 1 proceeds to Step C23 to cancel the activation of the vibrator 11. When judged that “vibration flag” has been stored (YES at Step C20), the CPU 1 judges whether or not a user is positioned near the display section 5 (whether or not a user is viewing the display section 5) based on an output signal from the human detection sensor 10 (Step C21).

When judged that no user is positioned near the display section 5 (NO at Step C21), the CPU 1 proceeds to Step C23 to cancel the activation of the vibrator 11. When judged that a user is positioned near the display section 5 (YES at Step C21), the CPU 1 starts the driving of the vibrator 11 based on this condition (Step C22). In this instance, the CPU 1 drives the vibrator 11 at an intensity adjusted in advance by the vibration adjustment processing. Then, the CPU 1 judges whether or not the playback has been performed to the end of the image data (Step C23). When judged that the playback has not been performed to the end of the image data (NO at Step C23), the CPU 1 continues the playback operation of the image and the driving of the vibrator 11 until the playback is performed to the end of the image data (partial video). When judged that the playback has been performed to the end of the image data (YES at Step C23), the CPU stops the driving of the vibrator 11 (Step C24), and proceeds to Step C16 in FIG. 8.

As described above, the CPU 1 of the present embodiment analyzes image data (video data or partial video data) displayed on the display section 5 to detect the changing state thereof, and controls the driving of the vibrator 11 depending on the detected changing state. Accordingly, when the partial video shown in FIG. 10A and FIG. 10B is displayed, the device itself vibrates along with the display of the dance on the frying pan. Also, when the video with audio shown in FIG. 10C and FIG. 10D is replayed, the device itself vibrates along with the burst of the balloon. Therefore, users' attentions can be strongly attracted by the special expression (generation of vibration) during the playback of images which is attractive expression (effect) and so adds extra value to the image display device, along with the increased variety in contents.

Note that, although vibration management information is set in advance according to the above-described embodiment, the vibrator 11 may be controlled by the CPU 1 calculating the change amount of the images of a video and the change amount of its sound during the playback of the video.

Additionally, in the above-described embodiment, the vibrator 11 is driven at an intensity adjusted in advance by vibration adjustment processing. However, the intensity of vibration may be controlled according to the changing state of image data or the changing state of audio data. As a result, a strong vibration can be generated when a changing state is significant, and a weak vibration can be generated when a changing state is insignificant.

Moreover, in the above-described embodiment, the digital photo frame is described which as a whole forms a substantially rectangular thin housing and is a standing type where the rectangular housing is placed upright to be horizontally long. However, the present invention is not limited thereto, and the digital photo frame may be a hanging-type digital photo frame. The present invention can be similarly applied to any type of digital photo frame.

Furthermore, in the above-described embodiment, the card IF 8 has been given as an example means for supplying various image data from an external source. However, a short-range wireless communication means (such as infrared communication and Bluetooth (registered trademark) communication), a wide area communication means using the Internet, and the like may be used.

Still further, in the above-described embodiment, a total change amount of a combination of two or more of the amount of change in size, the amount of change in position, the amount of change in color, and the amount of change in brightness may be detected as the change amount of image data. In this case, the combination for detection may be arbitrarily set by user operation. In addition, the changing state is not limited to the amount of change, and may be the rate of change, the percentage of change, the frequency of change, etc.

Yet still further, in the above-described embodiment, an image display device according to the present invention has been applied to a digital photo frame. However, the present invention may be applied to a mobile phone, a desktop electronic calculator, a personal computer (laptop computer), a pocket digital assistant (PDA), a digital camera, a music player, or the like including an image display section that displays a series of image data.

Yet still further, the “devices” or the “units” described in the above-described embodiments are not required to be in a single casing, and may be separated into a plurality of casings by function. In addition, the steps in the above-described flowcharts are not required to be processed in time series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An image display device that displays image data on a display section, comprising:
a vibration section which vibrates a housing constituting the image display device;
a detection section which analyzes video data that is displayed on the display section and thereby detects a changing state of an image in the video data; and
a vibration control section which controls driving of the vibration section based on the changing state of the image detected by the detection section.

2. The image display device according to claim 1, wherein the detection section analyzes the video data and thereby detects a movement amount of a moving image portion in the video data; and
the vibration control section controls the driving of the vibration section at a timing at which the moving image portion is replayed on the display section, when the movement amount of the moving image portion detected by the detection section is equal to or more than a predetermined change amount.

3. The image display section according to claim 1, wherein the detection section analyzes the video data and thereby detects any one of a change amount in size, a change amount in color, and a change amount in brightness of a moving image portion in the video data; and
the vibration control section controls the driving of the vibration section at a timing at which the moving image portion is replayed on the display section, when the change amount of the moving image portion detected by the detection section is equal to or more than a predetermined change amount.

4. The image display device according to claim 1, wherein the video data is a composite image in which a video has been combined with a portion of a still image serving as background; and
the detection section analyzes a video portion in the composite image and thereby detects a changing state of the video portion.

5. The image display device according to claim 1, further comprising:
a storage section which stores a plurality of image data including a still image and a video; and
a display switching section which sequentially switches and displays the plurality of image data stored in the storage section;
wherein the vibration control section operates when the display switching section switches display to display of video data.

6. The image display device according to claim 1, further comprising:
a human detection section which detects a person near the display section;
wherein the vibration control section controls the driving of the vibration section on a condition that the human detection section has detected the person.

7. The image display device according to claim 1, wherein the vibration control section controls intensity of vibration based on the changing state detected by the detection section when controlling the driving of the vibration section.

8. An image display device that displays image data on a display section, comprising:
a vibration section which vibrates a housing constituting the image display device;
a detection section which analyzes additional data that has been added to the image data that is displayed on the display section and thereby detects a changing state of the additional data; and
a vibration control section which controls driving of the vibration section based on the changing state of the additional data detected by the detection section.

9. The image display device according to claim 8, wherein the detection section analyzes audio data that has been added to the image data and thereby detects a changing state of the audio data where volume becomes equal to or greater than a predetermined volume; and
the vibration control section controls the driving of the vibration section at a timing at which image data corresponding to an audio portion with the volume equal to or greater than the predetermined volume is displayed on the display section, when the volume detected by the detection section is equal to or greater than the predetermined volume.

10. The image display device according to claim 9, further comprising:
a human detection section which detects a person near the display section;
wherein the vibration control section controls the driving of the vibration section on a condition that the human detection section has detected the person.

11. The image display device according to claim 10, wherein the vibration control section controls intensity of vibration based on the changing state detected by the detection section when controlling the driving of the vibration section.

12. The image display device according to claim 8, further comprising:
a storage section which stores a plurality of image data including a still image and a video; and
a display switching section which sequentially switches and displays the plurality of image data stored in the storage section;
wherein the vibration control section operates when the display switching section switches display to display of video data.

13. An image display device of a photo frame type including a display section, a storage section, a vibration section which vibrates a housing, and a processor;
wherein the storage section stores video data; and
the processor analyzes the video data and thereby detects a changing state of an image in the video data, generates vibration control data based on the detected changing state of the image, and controls driving of the vibration section based on the generated vibration control data when displaying the video data stored in the storage section on the display section.

14. The image display device according to claim 13, wherein the processor analyzes the video data and thereby detects a movement amount of a moving image portion in the video data, and generates control data for driving the vibration section at a timing at which the detected movement amount of the moving image portion becomes equal to or more than a predetermined change amount.

15. The image display device according to claim 13, wherein the video data is a composite image in which a video has been combined with a portion of a still image serving as background; and
the processor analyzes a video portion in the composite image and thereby detects a changing state of the video portion, and generates the vibration control data.

16. The image display device according to claim 13, wherein the storage section stores a plurality of still image data in addition to the video data; and
the processor sequentially switches and displays image data including a plurality of still images and a video stored in the storage section, and controls the driving of the vibration section based on the generated vibration control data when switching display to display of video data.

17. The image display device according to claim 13, further comprising:
a human detection section which detects a person near the display device;
wherein the processor controls the driving of the vibration section on a condition that the human detection section has detected the person.
